(19) United States
(12) Patent Application Publication
(10) Pub. No.: US 2005/0131795 A1
(43) Pub. Date: Jun. 16, 2005

(54) Method for managing investment funds

(76) Inventor: Dennis P. Barba JR., Chagrin Falls, OH (US)

Correspondence Address: Justin S. Rerko & Associates, LLC, 19836 Ellsworth Drive, Strongsville, OH, 44149, US

(21) Appl. No.: 10/970,122

(22) Filed: Oct. 21, 2004

Related U.S. Application Data
(60) Provisional application No. 60/529,662, filed on Dec. 15, 2003.

(51) Int. Cl. G06F 17/60

(52) U.S. Cl. 705/36

(57) ABSTRACT

A method for generating an investment portfolio comprised of a plurality of equity indices. The method includes defining at least one benchmark index; compiling a first set of equity indices; identifying at least one performance criterion for comparing each equity index of the first set to the at least one benchmark index; comparing each equity index of the first set to the at least one benchmark index relative to the at least one identified performance criterion; generating a second set of equity indices by selecting for inclusion in the second set the equity indices of the first set that compare favorably to the at least one benchmark index relative to the at least one identified performance criterion; and creating an investment portfolio by generating at least one percentage combination of indices from the second set of equity indices such that the investment portfolio, as defined by the percentage combinations of indices, compares favorably to the at least one benchmark index relative to the at least one identified performance criterion.

### CROSS REFERENCE TO RELATED APPLICATIONS

This application claims the benefit of U.S. Provisional Application Ser. No. 60/529,662, filed 15 Dec. 2003, the contents of which are hereby incorporated by reference.

### FIELD OF THE INVENTION

The present invention relates generally to business methods. More particularly, present invention relates to methods for managing investment funds through generation of a portfolio based on combinations of indices.

BRIEF DISCUSSION OF THE RELATED ART

Developing models to generate investment portfolios has long been a task of investment managers. Different types of investment methods and strategies have been devised, but there remains an inability to formulate a portfolio capable of consistently outperforming a benchmark index while being less volatile than the benchmark index.

Further limitations and disadvantages of traditional approaches will become apparent to one of ordinary skill in the art, through comparison of such traditional approaches with the present invention as described and claimed herein.

### BRIEF SUMMARY OF THE INVENTION

In accordance with one aspect, the present invention provides a method for generating an investment portfolio comprised of a plurality of equity indices. An example method generally includes the steps of defining at least one benchmark index; compiling a first set of equity indices; identifying at least one performance criterion for comparing each equity index of the first set to the at least one benchmark index; comparing each equity index of the first set to the at least one benchmark index relative to the at least one identified performance criterion; generating a second set of equity indices by selecting for inclusion in the second set the equity indices of the first set that compare favorably to the at least one benchmark index relative to the at least one identified performance criterion; and creating an investment portfolio by generating at least one percentage combination of indices from the second set of equity indices such that the investment portfolio, as defined by the percentage combinations of indices, compares favorably to the at least one benchmark index relative to the at least one identified performance criterion.

In accordance with another aspect, the performance criterion is at least one of a monthly average return criterion and a volatility criterion.

In accordance with another aspect, the portfolio generated by the present methods comprises 20-30% of a Russell 1000 Value Index, 25-40% of a S&P 100 Index, 10-20% of a S&P/Barra 500 Growth Index, and 15-30% of a DJIA Index. In accordance with another aspect, the portfolio comprises 27-29% of the Russell 1000 Value Index, 38-40% of the S&P 100 Index, 12-14% of the S&P/Barra 500 Growth Index, and 18-24% of the DJIA Index. In accordance with yet another aspect, the portfolio comprises 27.5% of the Russell 1000 Value Index, 39.5% of the S&P 100 Index, 13% of the S&P/Barra 500 Growth Index, and 20% of the DJIA Index.

In accordance with another aspect, the portfolio of the present invention comprises 20-30% of a Russell 1000 Value Index, 25-40% of a S&P 100 Index, 10-20% of a S&P/Bara 500 Growth Index, and 15-30% of a DJIA Index.

In accordance with another aspect, the portfolio of the present invention comprises 20-30% of a S&P Midcap 400 Index, 35-50% of a Russell 2000 Value Index, 10-25% of a Russell Midcap Value Index, and 10-20% of a Russell Midcap Index.

In accordance with yet another aspect, the portfolio of the present invention comprises 5-25% of an Australia Index, 5-25% of a Belgium Index, 5-25% of a France Index, 5-25% of an Italy Index, 5-25% of a Pacific ex Japan Index, 5-25% of a Spain Index. and 5-25% of a Switzerland Index.

### BRIEF DESCRIPTION OF THE DRAWINGS

These and other features and a more thorough understanding of the invention may be achieved by referring to the following description and claims, taken in conjunction with the accompanying drawing, wherein:

FIG. 1 is flowchart illustrating various example steps for practicing the present invention.

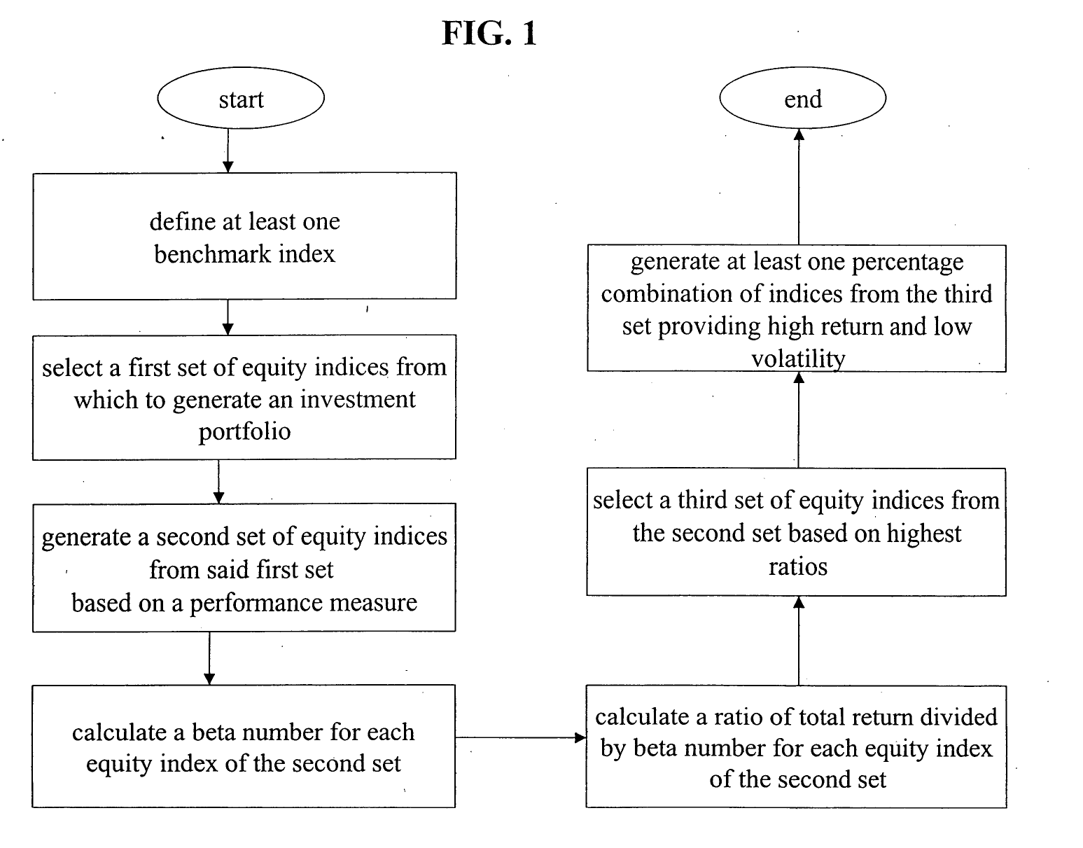

### DETAILED DISCUSSION OF EXAMPLE EMBODIMENTS

Disclosed according to the present invention are methods for generating an investment portfolio, particularly a portfolio comprised of indices. The portfolio generated by the methods of the present invention outperforms a benchmark index according to a chosen performance measure. The portfolio preferably outperforms the benchmark index while being subject to lower volatility (i.e., risk, Beta value, standard deviation, total return divided by a Beta value, etc.) than the benchmark index.

The methods of the present invention will be described herein with reference to the following example steps, methods and approaches. It is to be appreciated that the various steps, methods and approaches described are by way of example only and that any suitable methods can be employed to generate an investment portfolio as described herein.

Compile a First Set of Equity Indices

According to a preferred embodiment, the investment portfolio generated by the methods of the present invention comprises various combinations, and in various percentages, of a plurality of equity indices. Accordingly, it is necessary to compile a first set of equity indices from which the index/indices for the investment portfolio are selected. It is preferred that each index of the first set of equity indices be tracked by an Exchange Traded Fund (ETF), even more preferably ETFs with replication strategies, rather than representative strategies. This is a desirable approach as the ETF tracking each respective index is identical to the actual index in terms of the actual equity issues in both the index and the ETF.

An example first set of equity indices is listed in Table 1 below. Preferably, the first set of indices is comprised of indices that represent a plurality of asset classes and market capitalizations. It is to be appreciated that the list of indices in Table 1 is by way of example only and other indices suitably can be substituted and/or added, as appropriate.

TABLE 1

| | | |
|---|---|---|
| Russell 1000 Growth TR | Russell 100 TR | Russell 1000 Value TR |
| Russell 2000 Growth TR | Russell 2000 TR | Russell 2000 Value TR |
| Russell 3000 Growth TR | Russell 3000 TR | Russell 3000 Value TR |
| Russell MidCap | Russell MidCap TR | Russell MidCap |
| Growth TR | | Value TR |
| S&P 100 TR | S&P Midcap 400 | S&P/BARRA 500 |
| | TR | Growth TR |
| S&P/BARRA 500 | S&P/BRA MidCap | S&P/BARRA |
| Value TR | 400 Growth | MidCap 400 Value |
| S&P/BARRA | S&P/BARRA | Wilshire Real Estate |
| SmallCap 600 Growth | SmallCap 600 Value | Securities TR |

Define at Least One Benchmark Index

As more fully described below, the indices selected for inclusion in the investment portfolio are chosen based on their relative comparison and performance to one or more benchmark indices. Various benchmark indices operate as baselines against which the relative performance of an equity index can be compared as benchmark indices generally operate as indicators of the overall performance of a given market(s). Any known benchmark index is useful for the methods of the present invention. Suitable benchmark indices include, but are not limited to, the Dow Jones Industrial Average (DJIA), the S&P 500 Index, the Russell 2000 index, the MSCI EAFE Index, etc.

Identify at Least One Performance Criterion

The index components of the investment portfolio are selected based on their outperformance of the defined benchmark index(indices) along one or more performance criteria. Any known performance criterion is useful for practicing the methods of the present invention. Preferably performance criteria include, but are not limited to, return data, volatility, etc. The return data can be calculated according to any desired format, such as, for example, aggregate return data, average annual return data, average monthly return data, etc. Additionally, the return data, especially the average monthly return data can be calculated with reference to various time periods, such as 3 years, 5 years, 7 years, 10 years, 15 years, 23 years, etc, with the average monthly return being calculated for each of the respective timeframes.

The volatility criterion is another preferred criterion for measuring the performance of an equity index. Volatility is preferably quantified through any useful approach, such as standard deviation analysis, conventional Beta value analysis, where an issue's Beta value indicates its volatility relative to a benchmark, and other appropriate ratios, such as total return divided by Beta value. As regards Beta values, if a given issue has a Beta value of 1.00, its' movement generally follows that of the chosen benchmark (e.g., if the benchmark value rises or falls a certain proportion, the issue's value tends to rise or fall in the same proportion). As more fully described below, a Beta value for each equity index is preferably obtained through Capital Asset Pricing Model (“CAPM”) analysis.

Obtain Average Monthly Return Data for the Equity Indices and the Benchmark Index(Indices)

Once the first set of equity indices has been compiled and the benchmark index(indices) defined, the equity indices and benchmark indices are evaluated according to the chosen performance criterion(criteria). According to a preferred embodiment, the indices are evaluated according to average monthly return data computed for a plurality of time periods, such as, for example, 3 years, 5 years, 7 years, 10 years, 15 years, and 23 years, ending, for example, 31 Mar. 2002. To perform the calculations, monthly total return data, preferably including all dividend reinvestment, is obtained from a known source, such as a data content provider (e.g., Ibbottson & Associates, etc.). The average monthly return of each index is computed by known techniques.

Estimate Volatility for Each Index

The methods of the present invention are preferably useful for creating an investment portfolio that both yields a higher return than a given benchmark index and also exhibits lower volatility (e.g., a lower Beta value, standard deviation, total return to Beta value ratio, etc.) than the benchmark index. A preferred approach for estimating volatility is through Beta analysis, according to which a Beta value is estimated for each index for comparative purposes. As previously mentioned, the Capital Asset Pricing Model is a preferred tool for estimating Beta (“β”) values. The CAPM is defined by the formula:
R=R_{f}+β(Rₘ−R_{f})
wherein R represents the total return for the index, R_{f} represents the monthly Treasury bill rate, and Rₘ represents the market return (preferably measured based on the price return of the S&P 500). Accordingly, the Beta value is obtained by the following equation:
β=(R−R_{f})/(Rₘ−R_{f}).

This equation is used to derive a monthly average Beta value for each index. Additionally, Treasury bill historical data is available from known sources, such as the Federal Reserve Statistical Release H15, etc. Although volatility has been discussed with reference to Beta analysis, it is to be appreciated that any other approach, as exemplified above, for evaluating volatility can be employed.

Generate a Second Set of Equity Indices

Having defined the various indices and the desired performance criterion(criteria) and associated data, the first set of equity indices is compared to the benchmark index(indices) to identify equity indices that outperform the benchmark index(indices). According to a preferred embodiment, the equity indices are evaluated relative to average monthly return data and volatility (e.g., Beta values, standard deviation, total return to Beta value ratio, etc.) so that a portfolio yielding a higher return than the market and exhibiting lower volatility is obtained.

A preferred approach for identifying indices that exhibit the desired qualities (e.g., higher relative returns and lower relative volatility) is to employ the ratio: monthly rate of return (abs(monthly beta). The ratio is calculated for each equity index and for each chosen benchmark index and thereby equity indices are identified that outperform the market (as represented by the ratio computed for the benchmark index). In more detail, if the equity index ratio is larger than the benchmark index ratio, the equity index displays a higher return (due to the larger numerator) and a lower Beta value. Accordingly, the second set of equity indices is generated by compiling those equity indices of the first set that satisfy the chosen performance criterion(criteria).

According to a preferred embodiment, the relative performance of each equity index versus the benchmark index is evaluated according to different time frames, such as, for example, 3 years, 5 years, 7 years, 10 years, 15 years and 23 years. Accordingly, the above example methods are used to identify equity indices beating the market on each of the 3 years, 5 years, 7 years, 10 years, 15 years, and 23 years time frames. With regard to a specific example, the above methods applied to the example first set of equity indices of Table I identified six indices that beat the S&P 500 on several occasions during the 23 year time frame. These indices include: Russell 1000 Value TR, Russell 3000 Value TR, Russell Midcap Growth TR, S&P 100 TR, S&P/Barra 500 Growth TR, and Wilshire Real Estate Securities TR.

Identify an Ideal Percentage Combination of Equity Indices

Having generated the second set of equity indices (i.e., the set of equity indices that outperform the defined benchmark index(indices) according to the chosen performance criterion(criteria)), the methods are next applied to identify an optimal combination of the second set of equity indices to consistently perform according to a desired parameter. Preferably, and by way of example, the second set of equity indices are evaluated to identify an optimal combination of the indices that have consistently outperformed (i.e., yielded a higher return) the S&P 500 Index for each of the past 3 years, 5 years, 7 years, 10 years, 15 years and 23 years. Even more preferably, the second set of equity indices are also evaluated to identify combinations of indices that not only outperform the S&P 500, but also display lower volatility than the S&P 500.

The identification of an optimum combination of the second set of equity indices according to the above desired parameters can be calculated and evaluated according to any appropriate technique. Preferably, the calculations are performed by a technique that identifies an exact percentage of each equity index to include in the investment portfolio so that the investment portfolio is positioned to earn a higher return than the benchmark index over one or more of the previously described time periods, and be subject to lower volatility than the benchmark index. A preferred approach for performing these calculations is the creation and utilization of a customized C++ program.

Table 2 illustrates an example application of the above methods to identify a variety of optimum portfolio combinations based on comparison to the S&P 500 Index. For example, the methods identify that for a 5 year timeframe, an optimal portfolio, when evaluated relative to the S&P 500, consists of 93% of funds being in the Russell 1000 Value TR and 7% of the funds being in the Russell Midcap Growth TR.

TABLE 2
Benchmark Index = S&P 500

| | Timeframe | | | | | |
|---|---|---|---|---|---|---|
| Index | 3 Years | 5 Years | 7 Years | 10 Years | 15 Years | 23 Years |
| Russell 1000 Value TR | | 93% | | 100% | | |
| Russell 3000 Value TR | | | | | | 100% |
| Russell Midcap Growth TR | 36% | 7% | | | 3% | |
| S&P 100 TR | | | 100% | | 97% | |
| S&P/Barra 500 Growth TR | | | | | | |
| Wilshire Real Estate Securities TR | 64% | | | | | |

Table 3 illustrates an example application of the above methods to identify a variety of optimum portfolio combinations based on comparison to the DJIA. Thus, for example, the methods identify that for a 7 year timeframe, an optimal portfolio, when evaluated relative to the DJIA, consists of 31% of the funds being in the Russell 3000 Value TR and 69% of the funds being in the S&P 100 TR.

TABLE 3
Benchmark Index = DJIA

| | Timeframe | | | |
|---|---|---|---|---|
| Index | 3 Years | 5 Years | 7 Years | 10 Years |
| Russell 1000 Value TR | | | | 31% |
| Russell 3000 Value TR | | | 31% | |
| Russell Midcap Growth TR | | 77% | | |
| S&P 100 TR | | 1% | 69% | 69% |
| S&P/Barra 500 Growth TR | | 22% | | |
| Wilshire Real Estate Securities | 100% | | | |
| TR | | | | |

Generation of a Third Set of Equity Indices

Additional refinements of the can optionally be performed to further generate an optimal investment portfolio. For example, indices whose respective ETFs follow a representative model can be eliminated from the second set of equity indices, so that only indices with ETFs employing a replication model are included in the second set. Furthermore, various weighted average approaches can be used to further refine the portfolio. For example, a weighted average formula taking into consideration the number of times each equity index beat the S&P 500 and the DJIA, the Beta relative to the S&P 500 and DJIA, and the amount of excess return compared to the S&P 500 and the DJIA in each respective time period can be employed to reduce the second set of equity indices to include only those equity indices that optimize the performance of the portfolio. Employing the above refinements to the example second set of equity indices reduces the second set to a third set of equity indices comprising the following equity indices: Russell 1000 Value, S&P 100 and S&P/Barra 500 Growth. The various allocations and percentages can be further refined, optionally, by subtracting various percentages from the two highest weighted indices (Russell 1000 Value and S&P/Barra 500 Growth) and adding back in percentages of the S&P 500 and/or the DJIA. Such further refinements improve the performance of the portfolio and reduce its overall Beta value.

Generation of Optimal Investment Portfolio

Once the desired index components of the investment portfolio have been identified, the various indices are evaluated to identify an optimum percentage contribution of each index to the investment portfolio. With regard to the running example, the indices Russell 1000 Value, S&P 100, S&P/Barra 500 Growth, and S&P 500 and/or DJIA were evaluated to identify an optimum percentage of each index to be included in the investment portfolio. Standard calculations are performed to identify an optimum portfolio composition based on, for example, monthly rate of return and beta evaluated on different time frames, for example, 3 years, 5 years, 7 years, 10 years, 15 years, 23 years, etc. Through these calculations a model investment portfolio and its exact composition is identified that consistently outperforms the S&P 500 and displays a lower Beta value. As applied to the example third set of indices, the model portfolio composition is shown in Table 4.

TABLE 4
Range of Preferred Compositions of Investment Portfolio

| | Preferred | More Preferred | Most Preferred |
|---|---|---|---|
| Index | Composition | Composition | Composition |
| Russell 1000 Value | 20-30% | 27-29% | 27.5% |
| Index | | | |
| S&P 100 Index | 25-40% | 38-40% | 39.5% |
| S&P/Barra 500 Growth | 10-20% | 12-14% | 13% |
| Index | | | |
| DJIA | 15-30% | 18-24% | 20% |

Thus, a preferred composition of the investment portfolio, according to an example, includes 20-60% of the Russell 1000 Value Index, 25-40% of the S&P 100 Index, 10-20% of the S&P/Barra 500 Growth Index, and 15-30% of the DJIA. A more preferred composition of the investment portfolio includes 27-29% of the Russell 1000 Value Index, 38-40% of the S&P 100 Index, 12-14% of the S&P/Barra 500 Growth Index, and 18-24% of the DJIA. An even more preferred composition of the investment portfolio includes 27.5% of the Russell 1000 Value Index, 39.5% of the S&P 100 Index, 13% of the S&P/Barra 500 Growth Index, and 20% of the DJIA.

The above example methods can be used to create an investment portfolio that is positioned to outperform a benchmark index according to desired performance criteria. Additionally, and with reference to a preferred example embodiment, the above methods can be modified so as to produce an investment portfolio comprised essentially of a single type of asset class. For example, the methods can be used to construct a large cap equity investment portfolio, a small/madcap blended equity investment portfolio, an international equity investment portfolio, a portfolio consisting of indices representing one or more sectors, etc. Depending on the desired asset class of the investment portfolio, various benchmark indices can be used. For example, the S&P 500 Index can be used as a benchmark index for the large cap investment portfolio; the Russell 2000 Index can be used as a benchmark index for the small/madcap investment portfolio; and the MSCI EAFE Index can be used as a benchmark index for the international equity investment portfolio.

Further according to the example embodiment for creating an investment portfolio consisting of issues of a given asset class, the above methods are used to compare equity indices of a given asset class against a corresponding benchmark index. For example, equity indices representing an international equity asset class can be compared against the MSCI EAFE Index. The above techniques can be used to construct a portfolio for each asset class so that the portfolio preferably outperforms the benchmark index according to the desired criteria, e.g., rate of return, Beta values, etc. As described above, the portfolios created suitably yield a higher rate of return than the benchmark index and display a lower Beta value, thereby beating the market and being less risky than the market. Table 5 illustrates preferred compositions of example equity indices for each of the example asset class investment portfolios.

TABLE 5
Range of Preferred Compositions of Investment
Portfolio Relative to Asset Class

| | | | More | Most |
|---|---|---|---|---|
| | | Preferred | Preferred | Preferred |
| Model | Index | Composition | Composition | Composition |
| Large Cap | Russell 1000 | 20-30% | 23-27% | 28% |
| | Value Index | | | |
| | S&P 100 Index | 25-40% | 30-35% | 41% |
| | S&P/Barra 500 | 10-20% | 13-17% | 12% |
| | Growth Index | | | |
| | DJIA | 15-30% | 20-25% | 19% |
| Small/ | S&P Midcap | 20-30% | 23-27% | 26% |
| Midcap | 400 Index | | | |
| | Russell 2000 | 35-50% | 40-45% | 47% |
| | Value Index | | | |
| | Russell Midcap | 10-25% | 15-20% | 14% |
| | Value Index | | | |
| | Russell Midcap | 10-20% | 13-17% | 13% |
| | Index | | | |
| International | Australia | 5-25% | 10-20% | 20% |
| | Belgium | 5-25% | 10-20% | 6% |
| | France | 5-25% | 10-20% | 20% |
| | Italy | 5-25% | 10-20% | 20% |
| | Pacific ex | 5-25% | 10-20% | 7% |
| | Japan | | | |
| | Spain | 5-25% | 10-20% | 7% |
| | Switzerland | 5-25% | 10-20% | 20% |

Thus, a preferred composition for a large cap asset class investment portfolio includes 15-35%, more preferably 20-30%, even more preferably 23-27% of the Russell 1000 Value Index, 20-45%, more preferably 25-40%, even more preferably 30-35% of the S&P 100 Index, 5-25%, more preferably 10-20%, even more preferably 13-17% of the S&P/Barra 500 Growth Index, and 10-35%, more preferably 15-30%, even more preferably 20-25% of the DJIA. Various other combinations of indices for each of the small/madcap asset class investment portfolio and the international asset class investment portfolio are as illustrated in Table 5.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

1. A method for generating an investment portfolio comprised of a plurality of equity indices, the method comprising:
defining at least one benchmark index;
compiling a first set of equity indices;
identifying at least one performance criterion for comparing each equity index of the first set to the at least one benchmark index;
comparing each equity index of the first set to the at least one benchmark index relative to the at least one identified performance criterion;
generating a second set of equity indices by selecting for inclusion in the second set the equity indices of the first set that compare favorably to the at least one benchmark index relative to the at least one identified performance criterion; and
creating an investment portfolio by generating at least one percentage combination of indices from the second set of equity indices such that the investment portfolio, as defined by the percentage combinations of indices, compares favorably to the at least one benchmark index relative to the at least one identified performance criterion.

2. The method of claim 1, wherein the performance criterion is at least one of a monthly average return criterion and a volatility criterion.

3. The method of claim 2, wherein the volatility criterion is at least one selected from the group consisting of a Beta value, a standard deviation value, and a ratio of total return to Beta value.

4. The method of claim 3, wherein the step of comparing each equity index of the first set to the at least one benchmark index relative to the at least one identified performance criterion is performed with reference to at least one predefined time period.

5. The method of claim 4, wherein the predefined time period is at least one of 3 years, 5 years, 7 years, 10 years, 15 years, and 23 years.

6. The method of claim 4 further comprising the step of identifying an asset class for the investment portfolio.

7. The method of claim 6, wherein the asset class is at least one of an identified sector, a large cap asset class, a small/midcap asset class, and an international asset class.

8. The method of claim 6, wherein the step of defining at least one benchmark index is performed relative to the identified asset class.

9. The method of claim 4, wherein the portfolio comprises 20-30% of a Russell 1000 Value Index, 25-40% of a S&P 100 Index, 10-20% of a S&P/Barra 500 Growth Index, and 15-30% of a DJIA Index.

10. The method of claim 9, wherein the portfolio comprises 27-29% of the Russell 1000 Value Index, 38-40% of the S&P 100 Index, 12-14% of the S&P/Barra 500 Growth Index, and 18-24% of the DJIA Index.

11. The method of claim 10, wherein the portfolio comprises 27.5% of the Russell 1000 Value Index, 39.5% of the S&P 100 Index, 13% of the S&P/Barra 500 Growth Index, and 20% of the DJIA Index.

12. The method of claim 6, wherein the asset class is a large cap asset class.

13. The method of claim 12, wherein the portfolio comprises 20-30% of a Russell 1000 Value Index, 25-40% of a S&P 100 Index, 10-20% of a S&P/Barra 500 Growth Index, and 15-30% of a DJIA Index.

14. The method of claim 13, wherein the portfolio comprises 28% of the Russell 1000 Value Index, 41% of the S&P 100 Index, 12% of the S&PiBarra 500 Growth Index, and 19% of the DJIA Index.

15. The method of claim 6, wherein the asset class is a small/midcap asset class.

16. The method of claim 15, wherein the portfolio comprises 20-30% of a S&P Midcap 400 Index, 35-50% of a Russell 2000 Value Index, 10-25% of a Russell Midcap Value Index, and 10-20% of a Russell Midcap Index.

17. The method of claim 16, wherein the portfolio comprises 26% of the S&P Midcap 400 Index, 47% of a Russell 2000 Value Index, 14% of a Russell Midcap Value Index, and 13% of a Russell Midcap Index.

18. The method of claim 6, wherein the asset class is an international asset class.

19. The method of claim 18, wherein the portfolio comprises 5-25% of an Australia Index, 5-25% of a Belgium Index, 5-25% of a France Index, 5-25% of an Italy Index, 5-25% of a Pacific ex Japan Index, 5-25% of a Spain Index, and 5-25% of a Switzerland Index.

20. The method of claim 19, wherein the portfolio comprises 20% of an Australia Index, 6% of a Belgium Index, 20% of a France Index, 20% of an Italy Index, 7% of a Pacific ex Japan Index, 7% of a Spain Index, and 20% of a Switzerland Index.
